(19) United States
(12) Patent Application Publication
(10) Pub. No.: US 2025/0189060 A1
(43) Pub. Date: Jun. 12, 2025

(54) PIPE CLAMP STRUCTURE

(71) Applicant: CHIEN-TING LIN, Santa Fe Springs, CA (US)

(72) Inventor: CHIEN-TING LIN, Santa Fe Springs, CA (US)

(21) Appl. No.: 19/059,415

(22) Filed: Feb. 21, 2025

Related U.S. Application Data
(63) Continuation-in-part of application No. 17/212,356, filed on Mar. 25, 2021, now abandoned.

(51) Int. Cl. F16L 3/10; F16L 3/20

(52) U.S. Cl. CPC F16L 3/1091; F16L 3/20

(57) ABSTRACT

A pipe clamp structure for clamping a pipe includes: a first cylindrical base having first and second end circular surfaces, a first cylindrical side surface provided with a first thread at an outside thereof, and a first U-shaped groove; a first movable member having a first end with a first movable U-shaped groove and a second end; and a first rotating member having a first cylindrical accommodating part provided with a second thread therein. The first movable U-shaped groove is coupled with the first cylindrical base to form a first clamping space for clamping the pipe. The first cylindrical accommodating part is sleeved at the outside of the first cylindrical side surface; and the first thread and the second thread are engaged with each other. The first clamping space is reduced to clamp the pipe when locking and becomes larger to loosen the pipe when loosening.

### CROSS-REFERENCE TO RELATED APPLICATION

This application is a continuation-in-part of U.S. patent application Ser. No. 17/212,356 filed on Mar. 25, 2021, which is incorporated herewith by reference.

### BACKGROUND OF THE INVENTION

### 1. Field of the Invention

The present invention relates to a pipe clamp structure, and more particularly, to a pipe clamp structure that can solve the problems of deformation and an insufficient fixing force of a pipe clamp at the same time by using one movable member.

### 2. The Prior Arts

Common pipe clamps includes many types, and pipe clamps that can clamp pipes with different diameters and are convenient for assembly and disassembly also include many types. In a common type, two corresponding arc-shaped pieces are placed opposite to each other to form a clamping opening therebetween, and the connecting portions at both ends thereof are connected by fasteners, respectively. When disassembling, only one of the fasteners needs to be loosened.

Another existing pipe clamp, which is very similar to the present invention, has a U-shaped groove with threads on outer surfaces of both sides thereof and a cover with inner thread therein. When a pipe is placed into the U-shaped groove and the cover is closed, the pipe can be fixed by the pipe clamp by locking tight the corresponding threads of the U-shaped groove and the cover. Such pipe clamp can only be suitable for pipes with constant pipe diameters. For pipes with different pipe diameters, the clamping will be affected. Because only the periphery edge of the cover applies a force to the pipe, the cover and the pipe only contact at two points. As such, the locking force of the cover will act at the two points, thereby resulting in an excessive locking to cause the deformation of the pipe. If the arc of the U-shaped groove is consistent with that of the pipe, the U-shaped groove and the pipe form a curve surface contact, which can increase the friction force between the pipe clamp and the pipe to securely fix together. However, if the arc of the U-shaped groove is inconsistent with that of the pipe, the U-shaped groove and the pipe only form a straight line contact and thus there is less contact between the pipe and the pipe clamp, thereby resulting in an insufficient fixing force. Moreover, since there is no outward supporting structure at an inside of both sides of the U-shaped groove, when rotating the cover, it is easy to squeeze the both sides of the U-shaped groove inward, thereby causing deformation. As such, the corresponding threads of the cover and both sides of the U-shaped groove cannot be engaged with each other. In order to solve the problem of the insufficient fixing force, if such pipe clamp intends to clamp pipes with different pipe diameters, it is necessary to use a plurality of arc auxiliary accessories to match the pipes with different pipe diameters. In order to solve the problem of inward deformation on the both sides of the U-shaped groove, it is necessary to add an anti-deformation structure inside the cover. However, such design still cannot solve the problem of excessive locking or deformation of the pipe caused by the connection of the cover and the pipe at only two positions. In addition, such design also cannot solve the problem of inward deformation on the both sides of the U-shaped groove caused during rotating the cover, and the anti-deformation structure inside the cover will decrease the production efficiency.

Similarly, yet another existing pipe clamp includes a U-shaped groove with threads on outer surfaces at both sides thereof and a cover with inner threads, and further includes a circular disk piece. One side of the circular disk piece has an arc surface with a large arc, and two opposite arc openings are provided on a periphery edge of the circular disk piece. A pipe is placed into the U-shaped groove, the arc surface of the circular disk piece faces toward the U-shaped groove, the arc openings of the circular disk piece are respectively sleeved on both sides of the U-shaped groove, and the cover is placed thereon. By locking tight the corresponding threads of the U-shaped groove and the cover, the edge of the cover will push the periphery edge of the circular disk piece, and the arc surface of the circular disk piece will push toward the pipe to abut against the U-shaped groove to clamp the pipe. Such pipe clamp has the disadvantages that the size of the arc opening determines the pipe diameter range of the suitable pipes. The smaller the arc opening is, when the circular disk piece is close to a bottom of the U-shaped groove, it will be limited by the arc of the bottom, such that the circular disk piece cannot be further pushed forward, and the pipe diameter range of the pipe clamped by the pipe clamp becomes smaller. Also, if there are some protrusions on the pipe and the protrusions face the circular disk piece, when the pipe clamp is locked excessively, the center of the circular disk piece is blocked and cannot be pushed forward, while the cover acts on the periphery edge of the circular disk piece and continues to be pushed forward, thereby causing the deformation of the circular disk piece. In addition, such existing pipe clamp uses the periphery edge of the cover to apply force on the circular disc piece. Since there is no outward supporting structure at inside of the both sides of the U-shaped groove, it cannot solve the problem of inward deformation on the both sides of the U-shaped groove caused during rotating the cover.

The above two existing pipe clamps with a U-shaped groove have provided the corresponding solutions to the problems caused by these types of pipe clamp. The existing problems can be solved by just combining their solutions. However, it is needed to use a plurality of parts or structures, which may cause inconvenience in use or waste of resources.

### SUMMARY OF THE INVENTION

In order to overcome the problems of inward deformation on both sides of the existing U-shaped grooved pipe clamp and an insufficient fixing force caused by insufficient contact area between the pipe clamp and the pipe, the present invention provides a pipe clamp structure including a first U-shaped groove, a first movable member, and a first rotating member. The first movable member is provided with a first movable U-shaped groove. The pipe is placed into the first U-shaped groove, the first movable member is inserted into the first U-shaped groove, the first rotating member is pushed toward the first movable member, and the first movable U-shaped groove is pushed toward the pipe, such that the first U-shaped groove and the first movable U-shaped groove clamp tight the pipe. Such pipe clamp structure solves the problems of inward deformation on both sides of the existing U-shaped groove pipe clamp and an insufficient fixing force caused by insufficient contact area between the pipe clamp and the pipe at the same time by using the first movable member.

The technical solution adopted by the present invention to solve the technical problems is to provide a pipe clamp structure for clamping a pipe, comprising a first cylindrical base, a first movable member, and a first rotating member. The first cylindrical base has a first end circular surface, a second end circular surface, and a first cylindrical side surface. The first cylindrical base is provided with a first U-shaped groove along a direction from the second end circular surface toward the first end circular surface. The first U-shaped groove transversely penetrates the first cylindrical base and forms a first opening at the second end circular surface. The first cylindrical side surface is provided with a first thread at an outside thereof. The first movable member has a first end and a second end. The first end is provided with a first movable U-shaped groove along a direction toward the second end. The first end is embedded into the first U-shaped groove through the first opening and the first movable member is closely adjacent to both sides of the first U-shaped groove, and the first end and the both sides of the first U-shaped groove are slidable with each other. The first rotating member has a first cylindrical accommodating part. The first cylindrical accommodating part is provided with a second opening, a second thread, and a first bottom portion. The second end of the first movable member is accommodated in the first cylindrical accommodating part and adjacent to the first bottom portion. The pipe is placed into the first U-shaped groove through the first opening, such that the first movable U-shaped groove of the first movable member faces a direction toward the first opening and is coupled with the first cylindrical base. A first clamping space is formed between the first U-shaped groove and the first movable U-shaped groove. The first cylindrical accommodating part is sleeved at the outside of the first cylindrical side surface along the direction toward the first opening. The first thread and the second thread are engaged with each other. By locking tight the first thread and the second thread, the first bottom portion pushes the first movable member toward the first U-shaped groove, and the first clamping space is reduced to clamp tight the pipe. By loosening the first thread and the second thread, the first bottom portion and the first movable member are pushed backward, and the first clamping space becomes larger to loosen the pipe, such that the pipe can be slidable in the first clamping space, so as to adjust a position of the pipe.

Preferably, the both sides of the first U-shaped groove of the first cylindrical base are formed with two first arc concave portions corresponding to an arc of the first cylindrical base. Each of the first arc concave portions extends longitudinally to the second end circular surface. The first movable member is formed with two first arc convex portions corresponding to the two first arc concave portions. The first cylindrical base and the first movable member are coupled with each other, such that the two first arc concave portions are embedded with the two first arc convex portions, respectively.

Preferably, the second end of the first movable member and the first cylindrical accommodating part are provided with a first snap structure. The first snap structure allows the first movable member and the first cylindrical accommodating part to be coupled with each other and rotatable with each other.

Preferably, a fastener is provided at a predetermined position of the first end circular surface.

Preferably, the fastener is a long screw. A transverse groove is provided at another predetermined position of the first end circular surface. The long screw is provided with a nut knob. A bottom of the nut knob covers at least a part of the transverse groove. An object is placed in the transverse groove, and when the nut knob and the long screw are in a tight-locked state, the object is fixed in the transverse groove.

Preferably, a plurality of first barb members protrude from the first end circular surface. Each of the first barb members has a first upright portion and a first barb portion. The plurality of first barb members are arranged as a first annular structure centered on a center of the first end circular surface. Each of the first barb portions faces toward a radial direction.

Preferably, a first cylindrical recess is provided at a center of a bottom of the first U-shaped groove toward the first end circular surface. A first circular coupling opening is provided at a center of a bottom surface of the first cylindrical recess. A diameter of the first circular coupling opening is smaller than that of the first cylindrical recess.

Preferably, a first cylindrical coupling member is further provided. One end of the first cylindrical coupling member is accommodated in the first cylindrical recess, and penetrates the first circular coupling opening. Another end of the first cylindrical coupling member is provided with a first inner concave arc. The first inner concave arc is corresponding to a curvature and a position of an arc of the bottom of the first U-shaped groove.

Preferably, the pipe clamp structure further includes an extending part. The first cylindrical base is connected to a predetermined position of the extending part.

Preferably, the first end circular surface of the first cylindrical base has one of an arc surface shape, an ellipse-like shape, a square shape and a geometric polygon shape.

The beneficial effect of the present invention is that since the first movable member of the present invention can not only withstand a force due to the inward deformation on both sides of the first U-shaped groove when locking the first rotating member, but also be pushed by the first rotating member toward the pipe, by using the first movable U-shaped groove to increase the contact area with the pipe, the problems of inward deformation on both sides of the U-shaped groove pipe clamp and an insufficient fixing force caused by insufficient contact area between the pipe clamp and the pipe can be solved at the same time.

### BRIEF DESCRIPTION OF THE DRAWINGS

The present invention will be apparent to those skilled in the art by reading the following detailed description of a preferred embodiment thereof, with reference to the attached drawings, in which:

FIG. 1A is a schematic exploded perspective view of embodiment 1 of the present invention;

FIG. 1B is a schematic assembled perspective view of embodiment 1 of the present invention;

FIG. 1C is a variant of FIG. 1A of embodiment 1 of the present invention;

FIG. 1D is an end view showing that a first movable member is embedded into a first U-shaped groove of a first cylindrical base according to the embodiment of FIG. 1C;

FIG. 2A is a schematic assembled view of embodiment 1 of the present invention, in which a first pipe is assembled therein;

FIG. 2B is a schematic assembled cross-sectional view taken along line A-A according to embodiment 1 of the present invention;

FIG. 3 is a schematic exploded perspective view of embodiment 2 of the present invention;

FIG. 4A is a schematic exploded cross-sectional view of embodiment 3 of the present invention;

FIG. 4B is a schematic assembled cross-sectional view of embodiment 3 of the present invention;

FIG. 4C is a schematic exploded perspective view of embodiment 4 of the present invention;

FIG. 4D is a schematic assembled cross-sectional view of embodiment 4 of the present invention;

FIG. 5A is a schematic view of embodiment 5 of the present invention;

FIG. 5B is a schematic exploded perspective view of embodiment 6 of the present invention;

FIG. 5C is a schematic assembled perspective view of embodiment 6 of the present invention;

FIG. 6 is a schematic view of embodiment 7 of the present invention;

FIG. 7A is a schematic exploded perspective view of embodiment 8 of the present invention;

FIG. 7B is a schematic view of embodiment 8 of the present invention viewing from the second end circular surface toward the first end circular surface;

FIG. 8A is a schematic exploded cross-sectional view of embodiment 9 of the present invention;

FIG. 8B is a schematic assembled cross-sectional view of embodiment 9 of the present invention;

FIG. 9A is a schematic exploded cross-sectional view of embodiment 10 of the present invention;

FIG. 9B is a schematic assembled cross-sectional view of embodiment 10 of the present invention;

FIG. 10A is a schematic assembled cross-sectional view of a combination of embodiments 9 and 10 of the present invention, in which the second pipe and the third pipe are not assembled therein;

FIG. 10B is a schematic assembled cross-sectional view of a combination of embodiments 9 and 10 of the present invention, in which the second pipe and the third pipe are assembled therein;

FIG. 10C is a schematic assembled view of a combination of embodiments 9 and 10 of the present invention, in which the second pipe and the third pipe are assembled therein;

FIG. 11A is a schematic exploded cross-sectional view of embodiment 11 of the present invention;

FIG. 11B is a partially schematic assembled cross-sectional view of embodiment 11 of the present invention, wherein the spring is assembled therein;

FIG. 12 is a schematic perspective view of embodiment 12 of the present invention;

FIG. 13 is a schematic perspective view of embodiment 13 of the present invention; and

FIG. 14 is a schematic perspective view of embodiment 14 of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

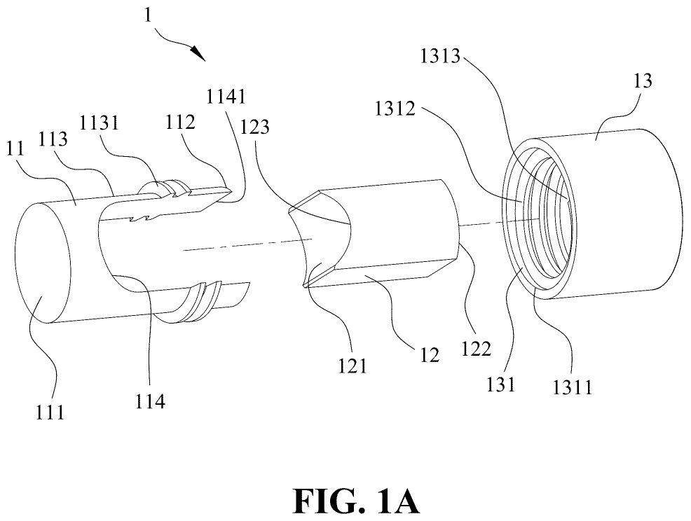

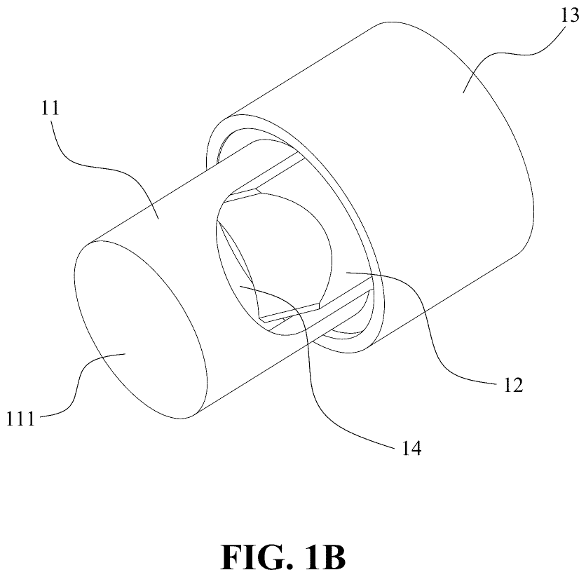

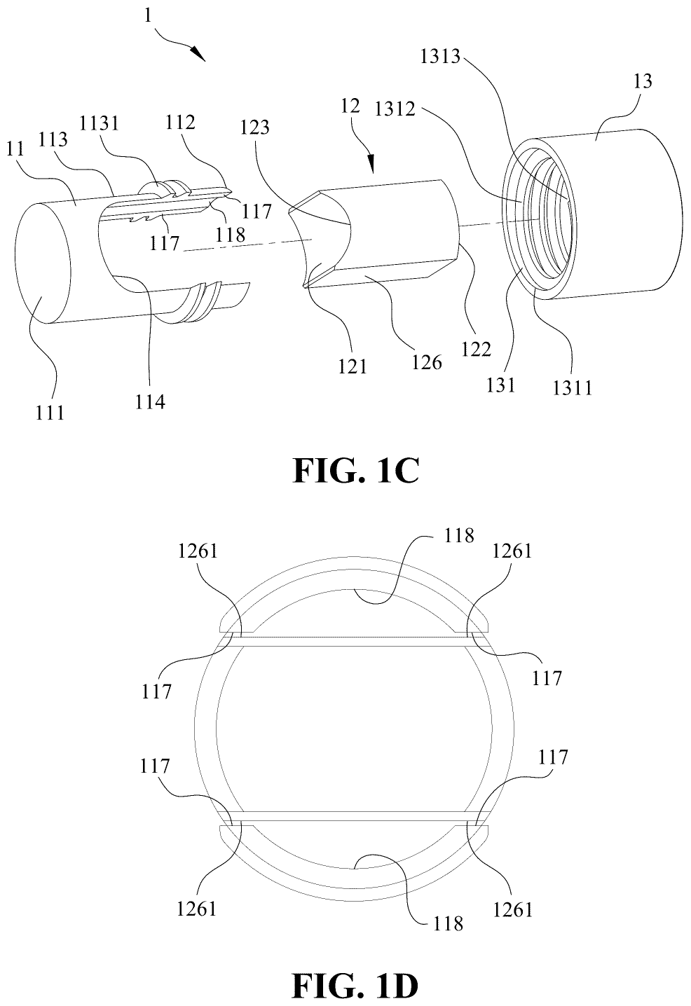

Hereinafter, embodiments of the present invention will be described according to FIGS. 1A to 14. This description is not intended to limit the embodiments of the present invention, but is one of the embodiments of the present invention.

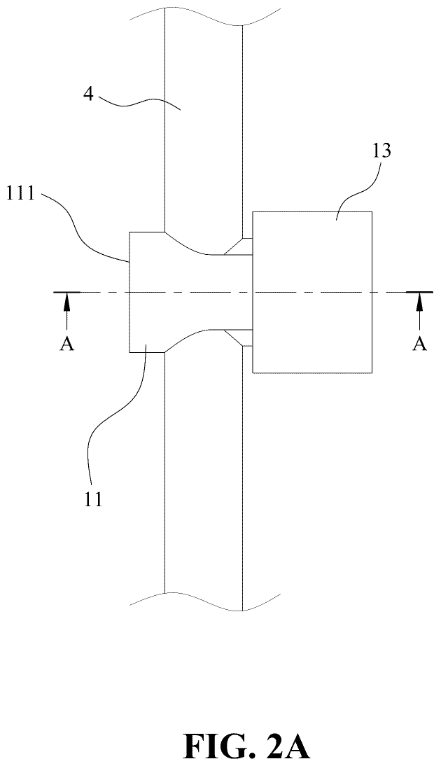

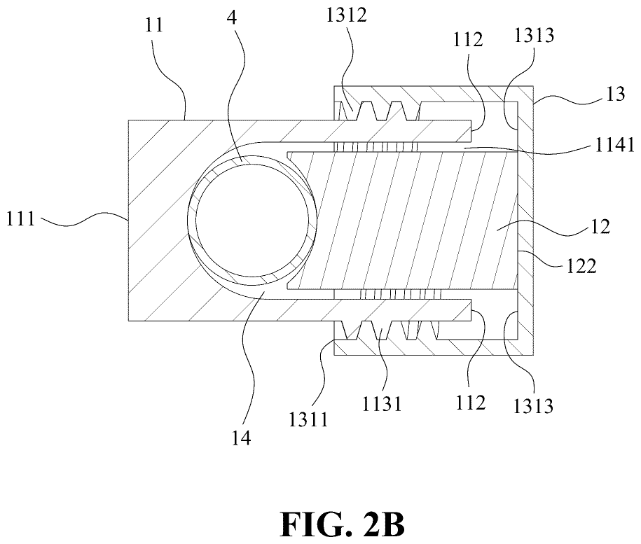

As shown in FIGS. 1A to 2B, a pipe clamp structure 1 for clamping a first pipe 4 according to embodiment 1 of the present invention includes a first cylindrical base 11, a first movable member 12, and a first rotating member 13. The first cylindrical base 11 has a first end circular surface 111, a second end circular surface 112, and a first cylindrical side surface 113. The first cylindrical base 11 is provided with a first U-shaped groove 114 along a direction from the second end circular surface 112 toward the first end circular surface 111. The first U-shaped groove 114 transversely penetrates the first cylindrical base 11 and forms a first opening 1141 at the second end circular surface 112. The first cylindrical side surface 113 is provided with a first thread 1131 at an outside thereof. The first movable member 12 has a first end 121 and a second end 122. The first end 121 is provided with a first movable U-shaped groove 123 along a direction toward the second end 122. The first end 121 can be embedded into the first U-shaped groove 114 through the first opening 1141 and the first movable member 12 is closely adjacent to both sides of the first U-shaped groove 114, and the first movable member 12 and the both sides of the first U-shaped groove 114 are slidable with each other. The first rotating member 13 has a first cylindrical accommodating part 131. The first cylindrical accommodating part 131 is provided with a second opening 1311, a second thread 1312, and a first bottom portion 1313. The second end 122 of the first movable member 12 can be accommodated in the first cylindrical accommodating part 131 and adjacent to the first bottom portion 1313. The first pipe 4 is placed into the first U-shaped groove 114 through the first opening 1141, such that the first movable U-shaped groove 123 of the first movable member 12 faces a direction toward the first opening 1141 and is coupled with the first cylindrical base 11. A first clamping space 14 is formed between the first U-shaped groove 114 and the first movable U-shaped groove 123. The first cylindrical accommodating part 131 is sleeved at the outside of the first cylindrical side surface 113 along the direction toward the first opening 1141. The first thread 1131 and the second thread 1312 are engaged with each other. By locking tight the first thread 1131 and the second thread 1312, the first bottom portion 1313 pushes the first movable member 12 toward the first U-shaped groove 114, and the first clamping space 14 is reduced to clamp tight the first pipe 4. By loosening the first thread 1131 and the second thread 1312, the first bottom portion 1313 and the first movable member 12 are pushed backward, and the first clamping space 14 becomes larger to loosen the first pipe 4, such that the first pipe 4 can slide in the first clamping space 14, so as to adjust a position of the first pipe 4. In embodiment 1 of the present invention, the first movable member 12 is provided inside the first U-shaped groove 114, thereby can prevent the problem of deformation of both sides of the first U-shaped groove 114. In addition, since the second end 122 is adjacent to the first bottom portion 1313, by pushing the first bottom portion 1313 toward the second end 122, the first clamping space 14 becomes smaller, such that the purpose of fixing the pipe clamp structure of embodiment 1 and the first pipe 4 with each other can be achieved. In the present invention, the problems of the existing pipe clamp structure can be solved by only using one first movable member 12.

The first U-shaped groove 114 and the first movable U-shaped groove 123 of embodiment 1 may also be V-shaped grooves or other shapes with larger or smaller arc. As shown in FIGS. 1A and 2B, the first bottom portion 1313 is formed to block and push the second end 122 of the movable member 12. When the first thread 1131 and the second thread 1312 are engaged and the first rotating member 13 is rotated to lock the pipe 4 tightly, the first movable member 12 is blocked and pushed by the first bottom portion 1313 towards the first U-shaped groove 114. After the pipe clamp structure is assembled and tightened, the second end circular surface 112 of the first cylindrical base 11 and the second end 122 of the first movable member 12 are both accommodated inside the first rotating member 13.

Please refer to FIGS. 1C and 1D, which show a variant of FIG. 1A. The same elements and the description thereof will not be repeated again. The additional elements and/or features relative to FIG. 1A will be described below. The first U-shaped groove 114 of the first cylindrical base 11 has two inner walls facing to each other, and both side edges of each inner wall have a first contact surface 117. The first contact surface 117 may be a planar surface, but not limited thereto. Each inner wall may form an arc concave surface 118, but not limited thereto, between the two first contact surfaces 117. The first movable member 12 has two side walls 126 facing the two inner walls of the first U-shaped groove 114, respectively, and both side edges of each side wall 126 of the first movable member 12 have a second contact surface 1261. Each side wall 126 of the first movable member 12 may form a planar surface, but not limited thereto, between the two second contact surfaces 1261. The first end 121 of the first movable member 12 is embedded into the first U-shaped groove 114 of the first cylindrical base 11 through the first opening 1141, and the second contact surfaces 1261 of the first movable member 12 are closely adjacent to the first contact surfaces 117 of the two inner walls of the first U-shaped groove 114, and the first movable member 12 and the first U-shaped groove 114 of the first cylindrical base 11 are slidable but not rotatable with each other.

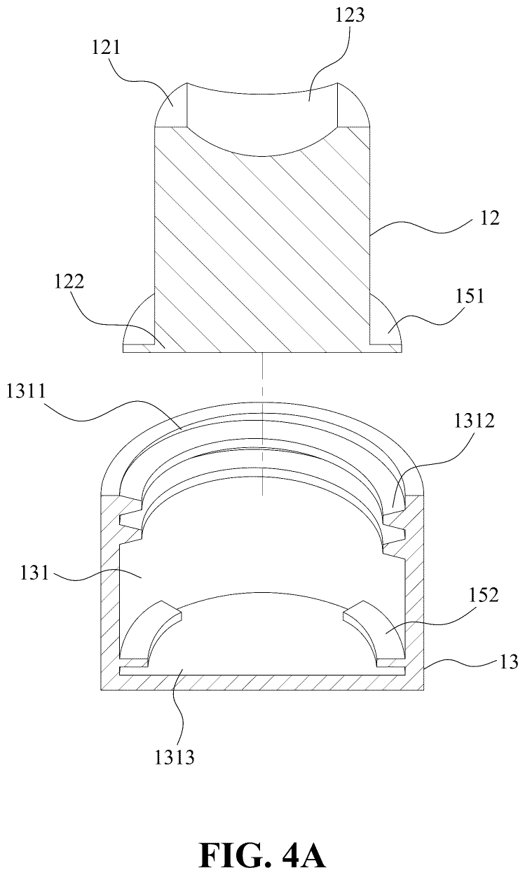

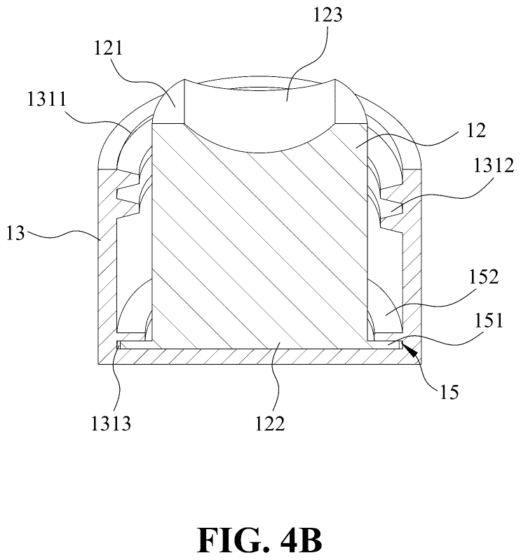

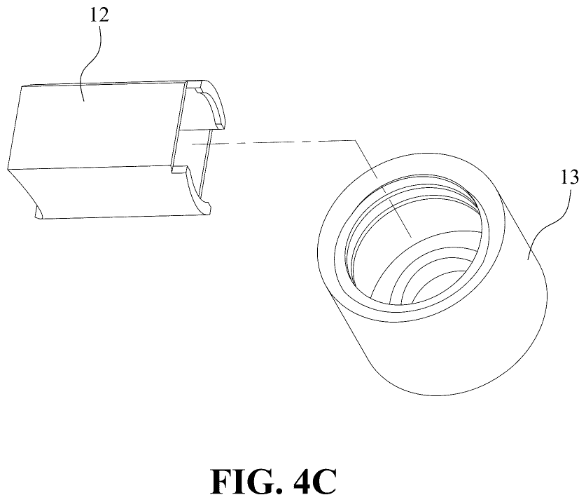

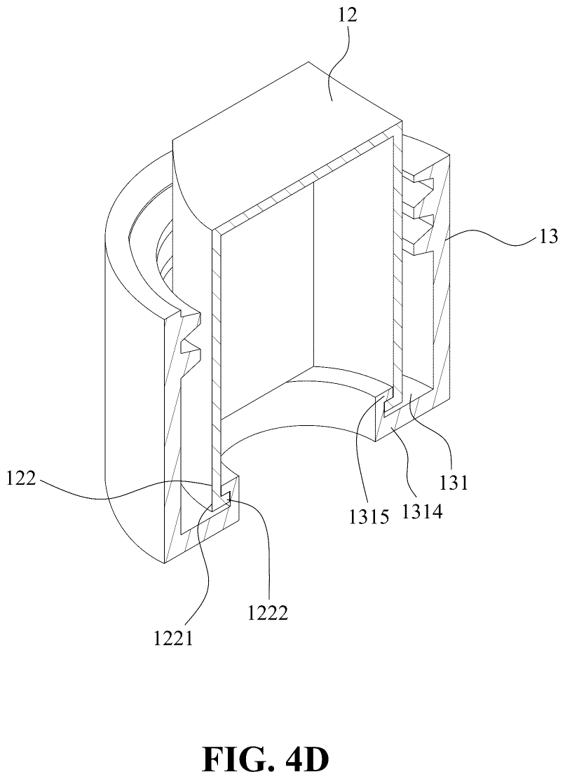

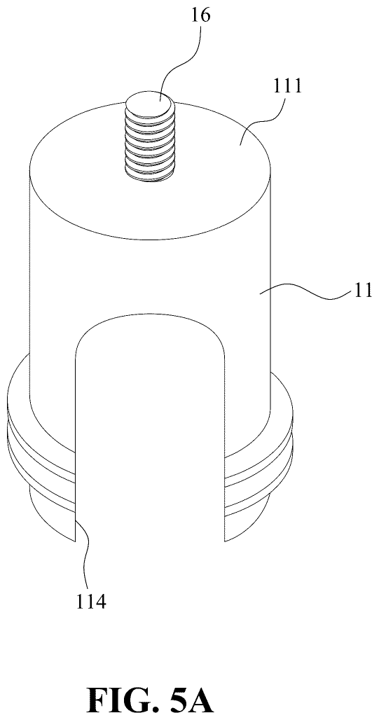

The followings are detailed descriptions of embodiments 2 to 10. In order to provide a clearer description, FIGS. 4A, 4B, 4D, 8A, 8B, 9A, 9B, 10A, 10B, 11A and 11B all are cross-sectional views of uniformly and longitudinally dissecting along a line passing through a center of each end circular surface.

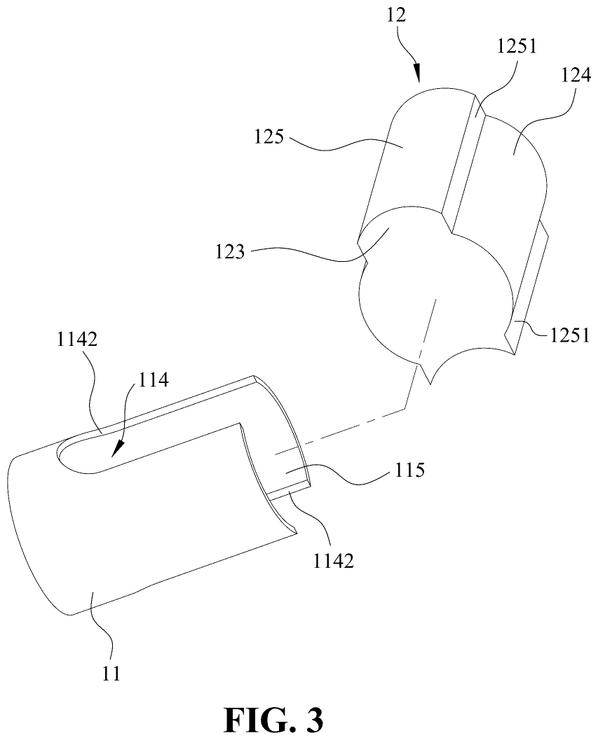

As shown in FIG. 3, which shows embodiment 2 of the present invention, the both sides of the first U-shaped groove 114 of the first cylindrical base 11 are formed with two first arc concave portions 115 corresponding to an arc of the first cylindrical base 11. Each of the first arc concave portions 115 extends longitudinally to the second end circular surface 112. The first movable member 12 is formed with two first arc convex portions 124 corresponding to the two first arc concave portions 115. The first cylindrical base 11 and the first movable member 12 are coupled with each other, such that the two first arc concave portions 115 are embedded with the two first arc convex portions 124, respectively. The pipe clamp structure of embodiment 2 can improve the coupling degree between the first cylindrical base 11 and the first movable member 12, and keep the direction of the first movable U-shaped groove 123, thereby solving the problem that the first movable member 12 rotates in the first U-shaped groove 114. Furthermore, the first movable member 12 may be provided with a protrusion 125 from upper and lower surfaces thereof. Each protrusion 125 has two side edges 1251 opposite to each other. The two side edges 1251 of the protrusion 125 are fitted with two longitudinal side edges 1142 of the first U-shaped groove 114 of the first cylindrical base 11 when the first movable member 12 is embedded into the first U-shaped groove 114 of the first cylindrical base 11, so that the first movable member 12 and the first U-shaped groove 114 of the first cylindrical base 11 may be slidable but not rotatable with each other.

As shown in FIGS. 4A and 4B, which show embodiment 3 of the present invention, the second end 122 of the first movable member 12 and the first cylindrical accommodating part 131 are provided with a first snap structure 15. The first snap structure 15 allows the first movable member 12 and the first cylindrical accommodating part 131 to be coupled with each other and rotatable with each other. As shown in FIG. 4A, the first snap structure 15 includes a first annular plane 151 and a plurality of first snap portions 152. The first annular plane 151 protrudes from a periphery edge of an appropriate position of the second end 122. The outer diameter of the first annular plane 151 is smaller than the inner diameter of the first cylindrical accommodating part 131. The plurality of first snap portions 152 protrude around inside of the first cylindrical accommodating part 131 and are close to an appropriate position of the first bottom portion 1313. The inner diameter of each of the snap portions is smaller than the outer diameter of the annular plane, and is larger than the outer diameter of the second end 122. The second end 122 is inserted into the first cylindrical accommodating part 131, and the second end 122 abuts against the first bottom portion 1313. As shown in FIG. 4B, the periphery edge of the first annular plane 151 is limited by the plurality of first snap portions 152, such that the first movable member 12 and the first rotating member 13 are rotatable with each other but cannot be separated. In embodiment 3, the first movable member 12 and the first rotating member 13 are coupled as an integrated part, thereby increasing the convenience of use and capable of avoiding the missing of components.

As shown in FIGS. 4C and 4D, which show embodiment 4 of the present invention, a second end extending portion 1221 forms outwardly at arc portions of the second end 122 of the first movable member 12, and an inner protruding step 1222 is provided on the inner side of the end of the second end extending portion 1221 toward a center of the arc portion. The bottom opening at the center of the first cylindrical accommodating part 131 is circular-shaped, and a periphery edge of the first cylindrical accommodating part 131 is formed with a first bottom extending portion 1314 toward the first cylindrical accommodating part 131. An outer protruding step 1315 is provided around the outer edge of the end of the first bottom extending portion 1314 in the radial direction. The outer protruding step 1315 and the inner protruding step 1222 form the first snap structure 15.

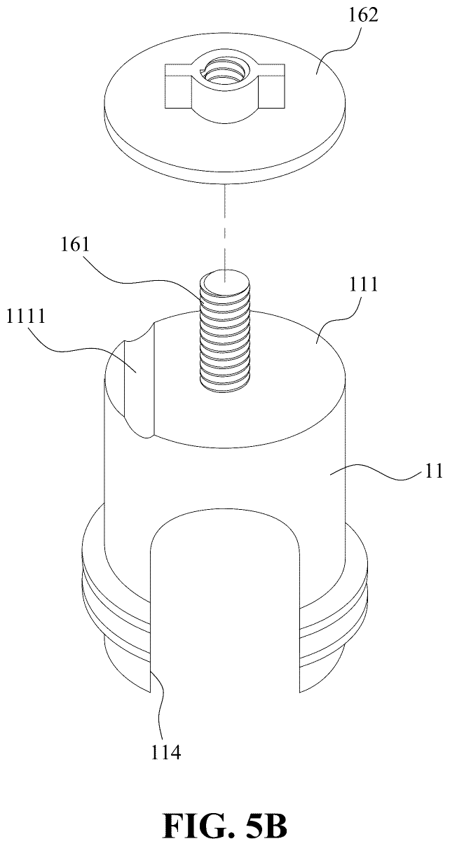

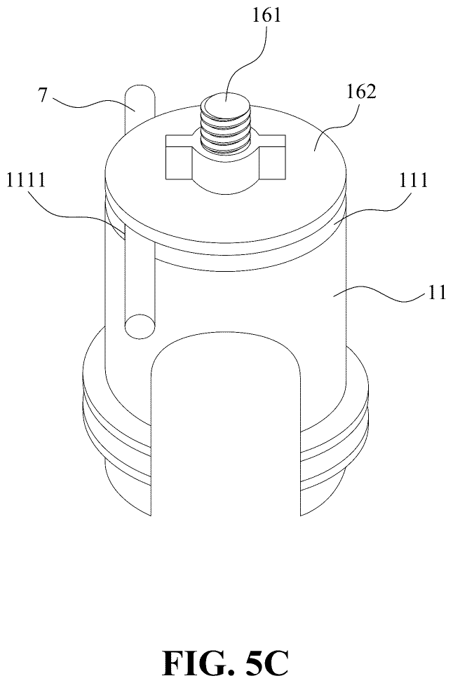

As shown in FIG. 5A, which shows embodiment 5 of the present invention, a fastener 16 is provided at an appropriate position of the first end circular surface 111. The fastener 16 of embodiment 5 can be a short screw, which can be connected to other apparatuses, such as a tripod head and a mobile phone clamp.

Preferably, as shown in FIGS. 5B and 5C, which show embodiment 6 of the present invention, the fastener 16 is a long screw 161, and a transverse groove 1111 is provided at an appropriate position of the first end circular surface 111. The long screw 161 is provided with a nut knob 162. A bottom of the nut knob 162 covers at least a part of the transverse groove 1111. As shown in FIG. 5C, an object 7 can be placed in the transverse groove 1111, and when the nut knob 162 and the long screw 161 are in a tight-locked state, the object 7 is fixed in the transverse groove 1111. This embodiment can be applied to a periphery edge of a clamping tool of a reflector or a pipe clamp of a clamping tool of a cantilever rod.

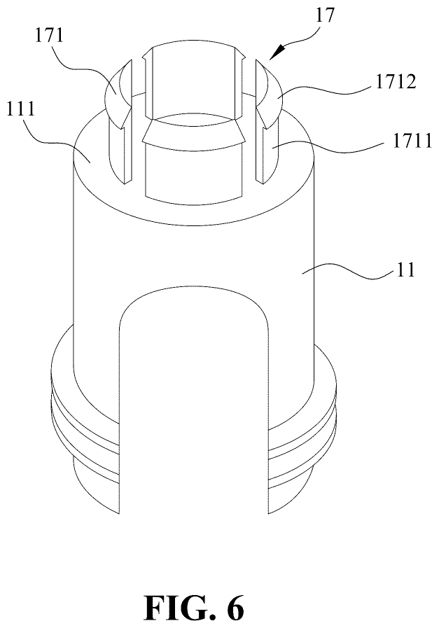

As shown in FIG. 6, which shows embodiment 7 of the present invention, a plurality of first barb members 171 protrude from the first end circular surface 111. Each of the first barb members 171 has a first upright portion 1711 and a first barb portion 1712. The plurality of first barb members 171 are arranged as a first annular structure 17 centered on a center of the first end circular surface 111. Each of the first barb portions 1712 faces toward the radial direction.

In embodiments 5, 6 and 7 of the present invention, the fastener 16, the long screw 161 and the barb member 171 are provided on the first end circular surface 111, respectively. The first end circular surface 111 is not limited to these embodiments, and can also be provided with other functional structures, such as a mobile phone live sound card tray or a mobile phone supporting base that can support three mobile phones.

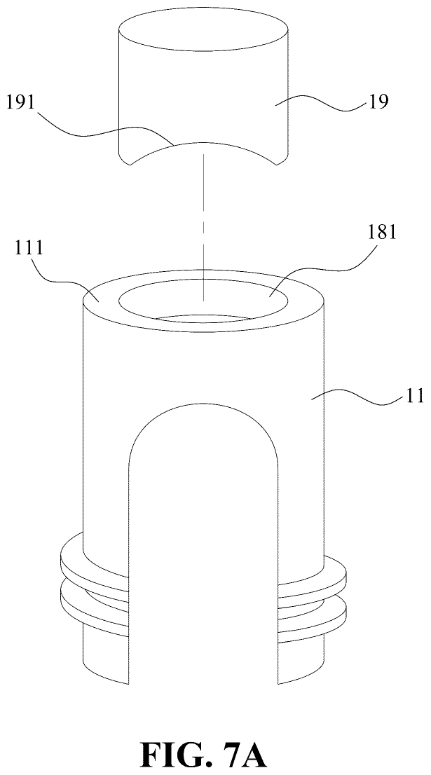

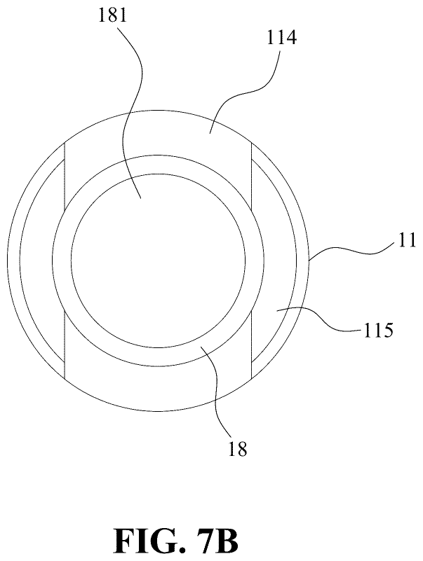

As shown in FIGS. 7A and 7B, which show embodiment 8 of the present invention, a first cylindrical recess 18 is provided at a center of a bottom of the first U-shaped groove 114 toward the first end circular surface 111. A first circular coupling opening 181 is provided at a center of a bottom surface of the first cylindrical recess 18. The diameter of the first circular coupling opening 181 is smaller than that of the first cylindrical recess 18.

As shown in FIG. 7A, a first cylindrical coupling member 19 is further provided. One end of the first cylindrical coupling member 19 can be accommodated in the first cylindrical recess 18, and can penetrate the first circular coupling opening 181. The other end of the first cylindrical coupling member 19 is provided with a first inner concave arc 191. The first inner concave arc 191 is corresponding to the curvature and position of the arc of the bottom of the first U-shaped groove 114.

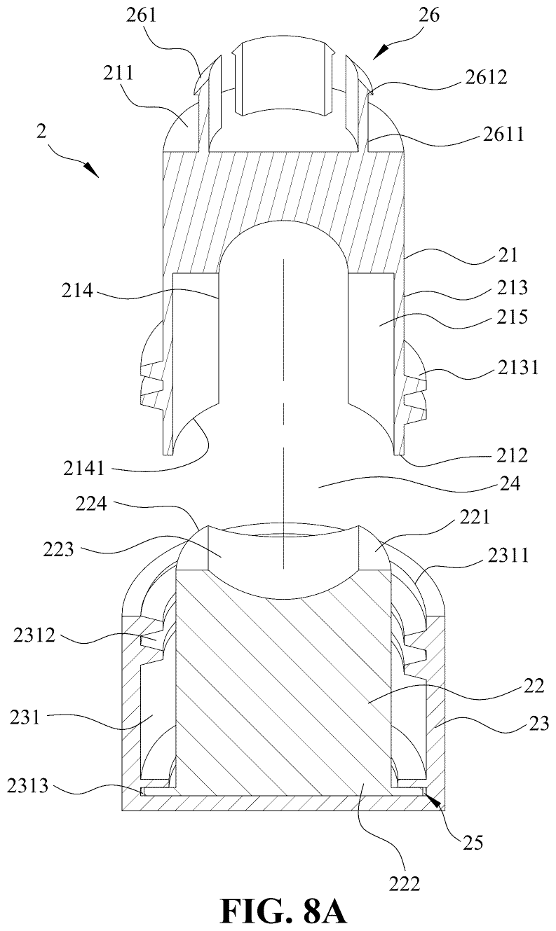

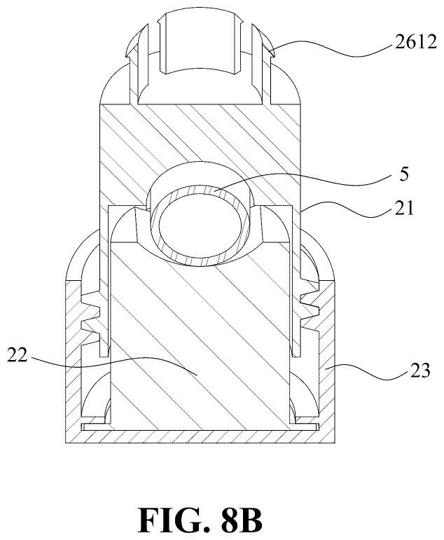

As shown in FIGS. 8A and 8B, a pipe clamp structure 2 for clamping a second pipe 5 according to embodiment 9 combining embodiments 1, 2, 3, and 7 of the present invention includes a second cylindrical base 21, a second movable member 22, and a second rotating member 23. The second cylindrical base 21 has a third end circular surface 211, a fourth end circular surface 212, and a second cylindrical side surface 213. The second cylindrical base 21 is provided with a second U-shaped groove 214 along a direction from the fourth end circular surface 212 toward the third end circular surface 211. The second U-shaped groove 214 transversely penetrates the second cylindrical base 21 and forms a third opening 2141 at the fourth end circular surface 212. The second cylindrical side surface 213 is provided with a third thread 2131 at an outside thereof. Both sides of the second U-shaped groove 214 of the second cylindrical base 21 are formed with two second arc concave portions 215 corresponding to the arc of the second cylindrical base 21. Each of the second arc concave portions 215 extends longitudinally to the fourth end circular surface 212. A plurality of second barb members 261 protrude from the third end circular surface 211. Each of the second barb members 261 has a second upright portion 2611 and a second barb portion 2612. The plurality of second barb members 261 are arranged as a second annular structure 26 centered on a center of the third end circular surface 211. Each of the second barb portions 2612 faces toward the radial direction. The second movable member 22 has a third end 221 and a fourth end 222. The third end 221 is provided with a second movable U-shaped groove 223 along a direction toward the fourth end 222. The third end 221 can be embedded into the second U-shaped groove 214 through the third opening 2141 and the second movable member 22 is closely adjacent to both sides of the second U-shaped groove 214, and the second movable member 22 and the both sides of the second U-shaped groove 214 are slidable with each other. The second movable member 22 is formed with two second arc convex portions 224 corresponding to the two second arc concave portions 215. The second cylindrical base 21 and the second movable member 22 are coupled with each other, such that the two second arc concave portions 215 are embedded with the two second arc convex portions 224, respectively. The second rotating member 23 has a second cylindrical accommodating part 231. The second cylindrical accommodating part 231 is provided with a fourth opening 2311, a fourth thread 2312, and a second bottom portion 2313. The fourth end 222 of the second movable member 22 can be accommodated in the second cylindrical accommodating part 231 and adjacent to the second bottom portion 2313. The fourth end 222 and the second cylindrical accommodating part 231 are provided with a second snap structure 25. The second snap structure 25 allows the fourth end 222 and the second cylindrical accommodating part 231 to be coupled with each other and rotatable with each other. The second pipe 5 is placed into the second U-shaped groove 214 through the third opening 2141, such that the second movable U-shaped groove 223 of the second movable member 22 faces a direction toward the third opening 2141 and is coupled with the second cylindrical base 21. The second arc concave portion 215 and the second arc convex portion 224 are embedded with each other and can slide directionally. A second clamping space 24 is formed between the second U-shaped groove 214 and the second movable U-shaped groove 223. The second cylindrical accommodating part 231 is sleeved at the outside of the second cylindrical side surface 213 along the direction toward the third opening 2141. The third thread 2131 and the fourth thread 2312 are engaged with each other. By locking tight the third thread 2131 and the fourth thread 2312, the second bottom portion 2313 pushes the second movable member 22 toward the second U-shaped groove 214, and the second clamping space 24 is reduced to clamp tight the second pipe 5. By loosening the third thread 2131 and the fourth thread 2312, the second bottom portion 2313 and the second movable member 22 are pushed backward, and the second clamping space 24 becomes larger to loosen the second pipe 5, such that the second pipe 5 can slide in the second clamping space 24, so as to adjust a position of the second pipe 5.

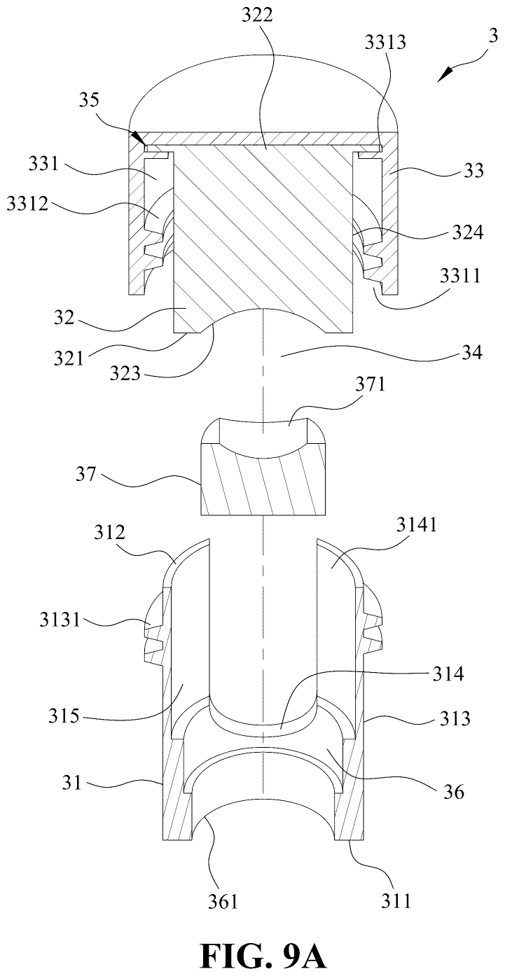

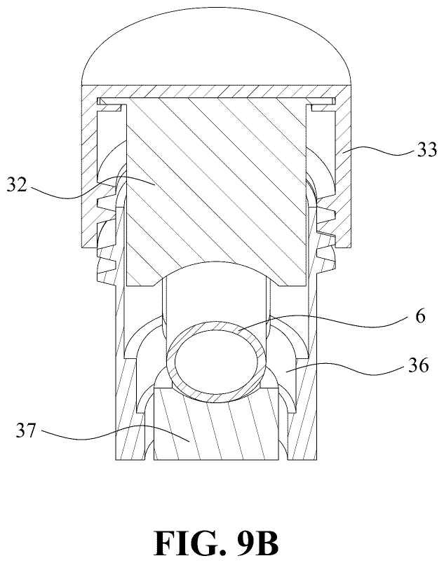

As shown in FIGS. 9A and 9B, a pipe clamp structure 3 for clamping a third pipe 6 according to embodiment 10 combining embodiments 1, 2, 3, and 8 of the present invention includes a third cylindrical base 31, a third movable member 32, and a third rotating member 33. The third cylindrical base 31 has a fifth end circular surface 311, a sixth end circular surface 312, and a third cylindrical side surface 313. The third cylindrical base 31 is provided with a third U-shaped groove 314 along a direction from the sixth end circular surface 312 toward the fifth end circular surface 311. The third U-shaped groove 314 transversely penetrates the third cylindrical base 31 and forms a fifth opening 3141 at the sixth end circular surface 312. The third cylindrical side surface 313 is provided with a fifth thread 3131 at an outside thereof. Both sides of the third U-shaped groove 314 of the third cylindrical base 31 are formed with two third arc concave portions 315 corresponding to the arc of the third cylindrical base 31. Each of the third arc concave portions 315 extends longitudinally to the sixth end circular surface 312; and a second cylindrical recess 36 is provided at a center of the bottom of the third U-shaped groove 314 toward the fifth end circular surface 311. A second circular coupling opening 361 is provided at a center of the bottom surface of the second cylindrical recess 36. The diameter of the second circular coupling opening 361 is smaller than that of the second cylindrical recess 36. A second cylindrical coupling member 37 is further provided. One end of the second cylindrical coupling member 37 can be accommodated in the second cylindrical recess 36, and can penetrate the second circular coupling opening 361. Another other end of the second cylindrical coupling member 37 is provided with a second inner concave arc 371. The second inner concave arc 371 is corresponding to the curvature and position of the arc of the bottom of the third U-shaped groove 314. The third movable member 32 has a fifth end 321 and a sixth end 322. The fifth end 321 is provided with a third movable U-shaped groove 323 along a direction toward the sixth end 322. The fifth end 321 can be embedded into the third U-shaped groove 314 through the fifth opening 3141 and the third movable member 32 is closely adjacent to both sides of the third U-shaped groove 314, and the third movable member 32 and the both sides of the third U-shaped groove 314 are slidable with each other. The third movable member 32 is formed with two third arc convex portions 324 corresponding to the two third arc concave portions 315. The third cylindrical base 31 and the third movable member 32 are coupled with each other, such that the two third arc concave portions 315 are embedded with the two third arc convex portions 324, respectively. The third rotating member 33 has a third cylindrical accommodating part 331. The third cylindrical accommodating part 331 is provided with a sixth opening 3311, a sixth thread 3312, and a third bottom portion 3313. The sixth end 322 of the third movable member 32 can be accommodated in the third cylindrical accommodating part 331 and adjacent to the third bottom portion 3313. The sixth end 322 and the third cylindrical accommodating part 331 are provided with a third snap structure 35. The third snap structure 35 allows the sixth end 322 and the third cylindrical accommodating part 331 to be coupled with each other and rotatable with each other. The third pipe 6 is placed into the third U-shaped groove 314 through the fifth opening 3141, such that the third movable U-shaped groove 323 of the third movable member 32 faces a direction toward the fifth opening 3141 and is coupled with the third cylindrical base 31. The third arc concave part 315 and the third arc convex portion 324 are embedded with each other and can slide directionally. A third clamping space 34 is formed between the third movable U-shaped groove 323 and the third U-shaped groove 314 as well as the second inner concave arc 371. The third cylindrical accommodating part 331 is sleeved at the outside of the third cylindrical side surface 313 along the direction toward the fifth opening 3141. The fifth thread 3131 and the sixth thread 3312 are engaged with each other. By locking tight the fifth thread 3131 and the sixth thread 3312, the third bottom portion 3313 pushes the third movable member 32 toward the third U-shaped groove 314, and the third clamping space 34 is reduced to clamp tight the third pipe 6. By loosening the fifth thread 3131 and the sixth thread 3312, the third bottom portion 3313 and the third movable member 32 are pushed backward, and the third clamping space 34 becomes larger to loosen the third pipe 6, such that the third pipe 6 can be slidable in the third clamping space 34, so as to adjust a position of the third pipe 6.

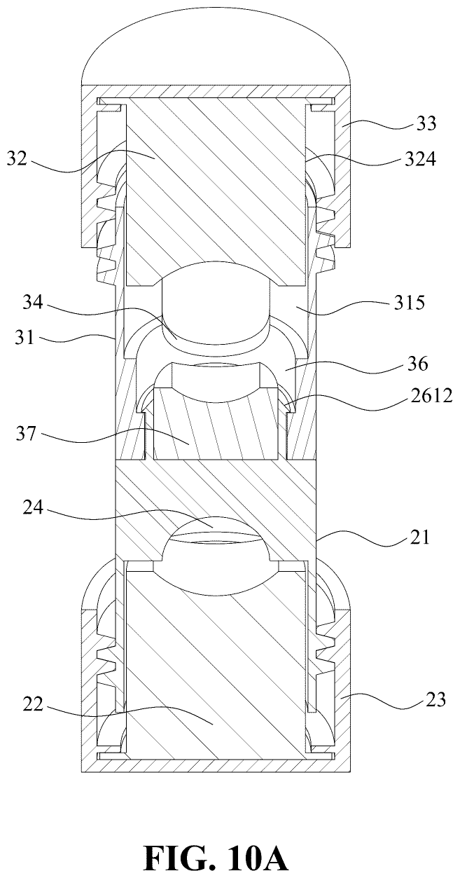

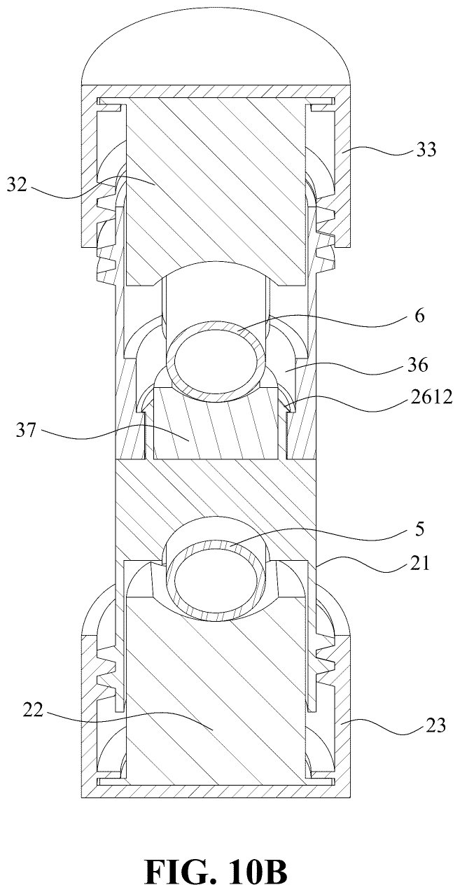

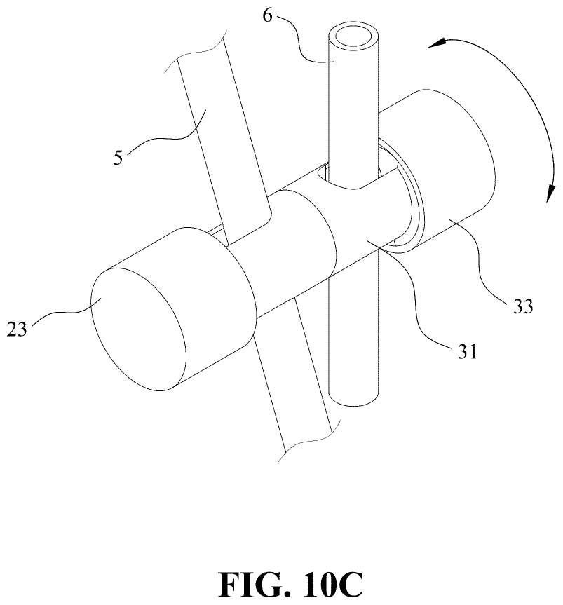

Please refer to FIGS. 10A to 10C, which show embodiment 11 of the present invention combining embodiments 9 and 10. As shown in FIG. 10A (also refer to FIGS. 8A, 8B, 9A and 9B), the third end circular surface 211 and the fifth end circular surface 311 face each other, and the second barb member 261 penetrates into the second circular coupling opening 361. Since the outer diameter of the second barb portion 2612 is larger than the second circular coupling opening 361, in the second cylindrical recess 36, the second barb portions 2612 hook the periphery edge of the second circular coupling opening 361, such that the second cylindrical base 21 and the third cylindrical base 31 are coupled with each other by the second barb member 261 and are rotatable with each other. The second cylindrical coupling member 37 is inserted into the second annular structure 26 from the bottom of the third U-shaped groove 314, such that the second barb member 261 is limited in the third cylindrical base 31 and cannot escape. The second inner concave arc 371 is corresponding to the curvature and position of the arc of the bottom of the third U-shaped groove 314. As shown in FIG. 10B, the third pipe 6 is placed into the third U-shaped groove 314 through the fifth opening 3141, such that the third movable U-shaped groove 323 of the third movable member 32 faces a direction toward the fifth opening 3141 and is coupled with the third cylindrical base 31. The third clamping space 34 is formed between the third movable U-shaped groove 323 and the third U-shaped groove 314 as well as the second inner concave arc 371. The third cylindrical accommodating part 331 is sleeved at the outside of the third cylindrical side surface 313 along the direction toward the fifth opening 3141. The fifth thread 3131 and the sixth thread 3312 are engaged with each other. By locking tight the fifth thread 3131 and the sixth thread 3312, the third bottom portion 3313 pushes the third movable member 32 toward the third U-shaped groove 314, and the third clamping space 34 is reduced, such that the second inner concave arc 371 and the third movable U-shaped groove 323 clamp tight the third pipe 6, and the second cylindrical coupling member 37 abuts against the third end circular surface 211, thereby the second cylindrical base 21 and the third cylindrical base 31 are not rotatable with each other. By loosening the fifth thread 3131 and the sixth thread 3312, the third bottom portion 3313 and the third movable member 32 are pushed backward, and the third clamping space 34 becomes larger to loosen the third pipe 6, such that the third pipe 6 can slide in the third clamping space 34, and the second cylindrical coupling member 37 and the third end circular surface 211 are separated, thereby the second cylindrical base 21 and the third cylindrical base 31 are rotatable with each other, so as to adjust the relative position and angle of the third pipe 6 and the second pipe 5 as shown in FIG. 10C. This embodiment combines both embodiments 9 and 10 to form a set of pipe clamp structure that can control the relative position and angle of the two pipes.

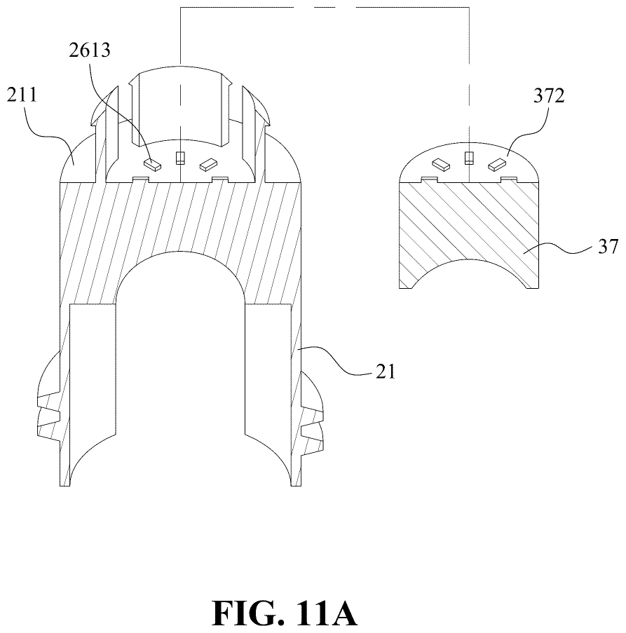

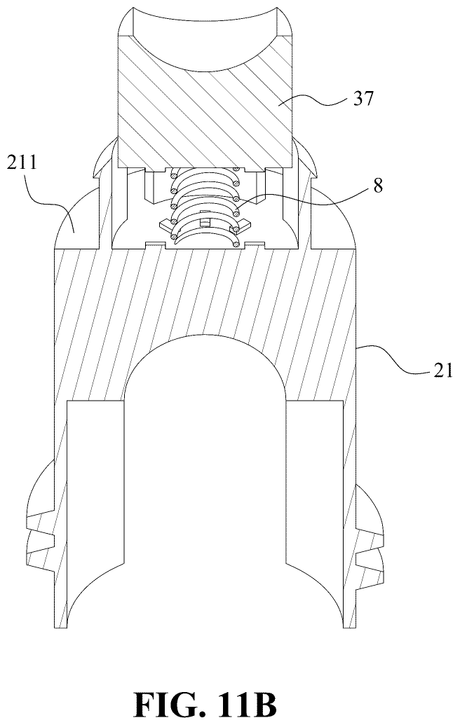

Preferably, FIGS. 11A and 11B show embodiment 11 of the present invention. As shown in FIG. 11A, a first gear disk 2613 may be provided on the third end circular surface 211 in the second annular structure 26 (also see FIG. 8A). A second gear disk 372 corresponding to the first gear disk 2613 is provided at a corresponding position of the second cylindrical coupling member 37 coupled with the third end circular surface 211. The second cylindrical coupling member 37 is pushed toward the third end circular surface 211, such that the first gear disk 2613 and the second gear disk 372 are engaged with each other, thereby the second cylindrical base 21 and the third cylindrical base 31 are not rotatable with each other. In this embodiment, a spring member 8 can be provided between the first gear disk 2613 and the second gear disk 372 as shown in FIG. 11B, which can increase the smoothness of mutual rotation.

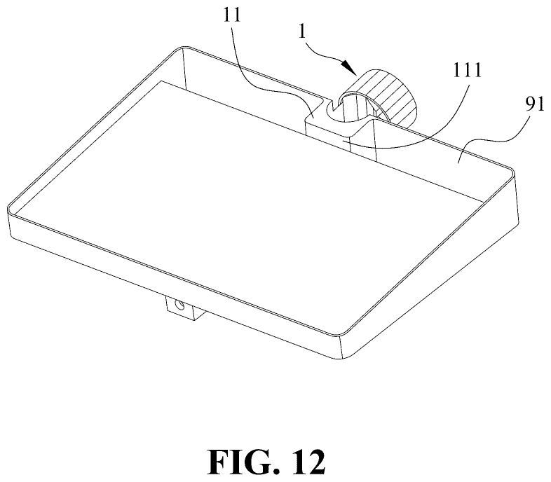

FIG. 12 is a schematic perspective view of embodiment 12 of the present invention. As shown in FIG. 12, the pipe clamp structure 1 further includes an extending part 91. Taking this embodiment as an example, the extending part 91 is a tray, which can be used as a mobile phone live sound card tray. In this embodiment, the first cylindrical base 11 is connected to an appropriate position at a center of the tray to form as an integrated part. Since the overall shape of the tray is mainly square shape, the shape of the first end circular surface 111 of the first cylindrical base 11 should also be designed as square shape to conform to the consistency in the design of the overall appearance.

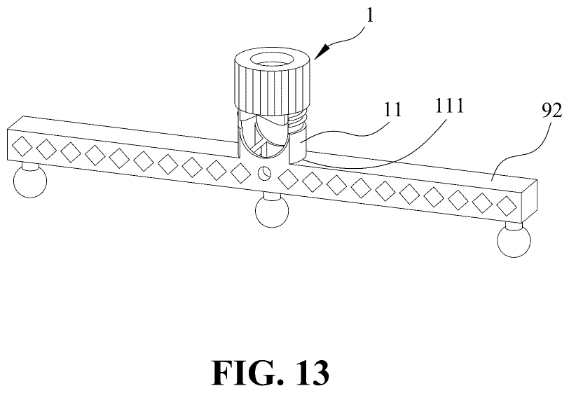

FIG. 13 is a schematic perspective view of embodiment 13 of the present invention. As shown in FIG. 13, the pipe clamp structure 1 further includes an extending part 92. Taking this embodiment as an example, the extending part 92 is a mobile phone supporting base that can be used to support three mobile phones. In this embodiment, the first cylindrical base 11 is connected to an appropriate position at a center of the mobile phone supporting base to form as an integrated part. In this embodiment, the shape of the first end circular surface 111 of the first cylindrical base 11 is designed as ellipse-like shape.

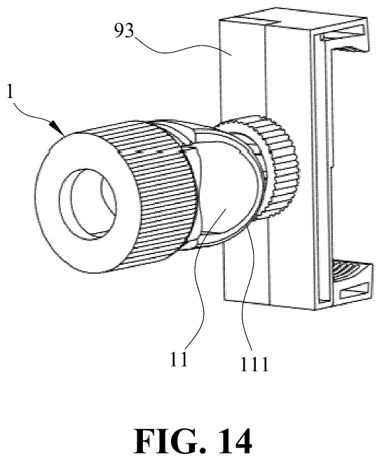

FIG. 14 is a schematic perspective view of embodiment 14 of the present invention. As shown in FIG. 14, the pipe clamp structure 1 further includes an extending part 93. Taking this embodiment as an example, the extending part 93 is a mobile phone clamp that can clamp one mobile phone. In this embodiment, the first cylindrical base 11 is connected to an appropriate position of a support beam of the mobile phone clamp to form as an integrated part. In this embodiment, the shape of the first end circular surface 111 of the first cylindrical base 11 is designed as an arc surface.

In the embodiments shown in FIGS. 12 to 14, since the extending parts are different, the shapes of the first end circular surfaces 111 of the first cylindrical bases 11 are designed as different shapes, correspondingly. Although the above embodiments show the arc surface shape, ellipse-like shape and square shape, it is not limited thereto. The angle of the arc surface or other geometric polygons can be adjusted according to actual product requirements, so as to conform the consistency in the design of the overall appearance.

The above description and explanation are only explanations of the preferred embodiments of the present invention. Those skilled in the art can make other modifications based on the scope defined by claims and based on the above description, but these modifications should not departure from the invention spirit of the present invention and should be included in the claimed scope of the present invention.

What is claimed is:

1. A pipe clamp structure for clamping a pipe, comprising:
a first cylindrical base, wherein the first cylindrical base has a first end circular surface, a second end circular surface, and a first cylindrical side surface; the first cylindrical base is provided with a first U-shaped groove along a direction from the second end circular surface toward the first end circular surface, and the first U-shaped groove transversely penetrates the first cylindrical base and forms a first opening at the second end circular surface; and the first cylindrical side surface is provided with a first thread at an outside thereof, wherein the first U-shaped groove has two inner walls facing to each other, both side edges of each inner wall have a first contact surface;
a first movable member, wherein the first movable member has a first end and a second end; the first end is provided with a first movable U-shaped groove along a direction toward the second end; the first movable member has two side walls facing the two inner walls of the first U-shaped groove, respectively, both side edges of each side wall of the first movable member have a second contact surface; the first end of the first movable member is embedded into the first U-shaped groove of the first cylindrical base through the first opening and the second contact surfaces of the first movable member are closely adjacent to the first contact surfaces of the two inner walls of the first U-shaped groove, and the first movable member and the first U-shaped groove of the first cylindrical base are slidable but not rotatable with each other; and
a first rotating member, wherein the first rotating member has a first cylindrical accommodating part, and the first cylindrical accommodating part is provided with a second opening, a second thread, and a first bottom portion; the second end of the first movable member is accommodated in the first cylindrical accommodating part and adjacent to the first bottom portion; the first bottom portion is used for blocking and pushing the second end of the first movable member towards the first U-shaped groove;
wherein the pipe is placed into the first U-shaped groove through the first opening, such that the first movable U-shaped groove of the first movable member faces a direction toward the first opening and is coupled with the first cylindrical base; a first clamping space is formed between the first U-shaped groove and the first movable U-shaped groove; the first cylindrical accommodating part is sleeved at the outside of the first cylindrical side surface along the direction toward the first opening; the first thread and the second thread are engaged with each other; by locking tight the first thread and the second thread, the first bottom portion blocks the first movable member and pushes the first movable member toward the first U-shaped groove, and the first clamping space is reduced to clamp tight the pipe with both the second end circular surface of the first cylindrical base and the second end of the first movable member being accommodated inside the first rotating member; by loosening the first thread and the second thread, the first bottom portion and the first movable member are pushed backward, and the first clamping space becomes larger to loosen the pipe, such that the pipe can be slidable in the first clamping space, so as to adjust a position of the pipe.

2. The pipe clamp structure according to claim 1, wherein both sides of the first U-shaped groove of the first cylindrical base are formed with two first arc concave portions corresponding to an arc of the first cylindrical base; each of the first arc concave portions extends longitudinally to the second end circular surface; the first movable member is formed with two first arc convex portions corresponding to the two first arc concave portions; the first cylindrical base and the first movable member are coupled with each other, such that the two first arc concave portions are embedded with the two first arc convex portions, respectively.

3. The pipe clamp structure according to claim 1, wherein the second end of the first movable member and the first cylindrical accommodating part are provided with a first snap structure; the first snap structure allows the first movable member and the first cylindrical accommodating part to be coupled with each other and rotatable with each other.

4. The pipe clamp structure according to claim 1, wherein a fastener is provided at a predetermined position of the first end circular surface.

5. The pipe clamp structure according to claim 4, wherein the fastener is a long screw; a transverse groove is provided at another predetermined position of the first end circular surface; the long screw is provided with a nut knob; a bottom of the nut knob covers at least a part of the transverse groove; an object can be placed in the transverse groove, and when the nut knob and the long screw are in a tight-locked state, the object is fixed in the transverse groove.

6. The pipe clamp structure according to claim 1, wherein a plurality of first barb members protrude from the first end circular surface; each of the first barb members has a first upright portion and a first barb portion; the plurality of first barb members are arranged as a first annular structure centered on a center of the first end circular surface; each of the first barb portions faces toward a radial direction.

7. The pipe clamp structure according to claim 1, wherein a first cylindrical recess is provided at a center of a bottom of the first U-shaped groove toward the first end circular surface; a first circular coupling opening is provided at a center of a bottom surface of the first cylindrical recess; a diameter of the first circular coupling opening is smaller than that of the first cylindrical recess.

8. The pipe clamp structure according to claim 7, further comprising a first cylindrical coupling member, wherein one end of the first cylindrical coupling member is accommodated in the first cylindrical recess, and penetrates the first circular coupling opening; another end of the first cylindrical coupling member is provided with a first inner concave arc; the first inner concave arc is corresponding to a curvature and a position of an arc of the bottom of the first U-shaped groove.

9. The pipe clamp structure according to claim 1, further comprising an extending part, wherein the first cylindrical base is connected to a predetermined position of the extending part.

10. The pipe clamp structure according to claim 9, wherein the first end circular surface of the first cylindrical base has one of an arc surface shape, an ellipse-like shape, a square shape and a geometric polygon shape.

11. The pipe clamp structure according to claim 1, wherein the first and second contact surfaces are a planar surface.
